(19) United States
(12) Patent Application Publication
(10) Pub. No.: US 2015/0223434 A1
(43) Pub. Date: Aug. 13, 2015

(54) Honeycomb Beehive Frame

(71) Applicant: Deanna Maher, Salem, MA (US)

(72) Inventor: Deanna Maher, Salem, MA (US)

(21) Appl. No.: 14/619,066

(22) Filed: Feb. 10, 2015

Related U.S. Application Data
(60) Provisional application No. 61/937,659, filed on Feb. 10, 2014.

(51) Int. Cl. A01K 47/02; A01K 47/04

(52) U.S. Cl. CPC A01K 47/02; A01K 47/04

(57) ABSTRACT

An improved beehive frame for containing and easily replacing wax honeycomb foundations. The frame contains four thin wires for holding a honeycomb, with two wires on either face of the honeycomb. Two wires on one face of the honeycomb have removable ends for loosening the two wires on the frame, allowing access to the contained honeycomb for removal and replacement.

### CROSS REFERENCE TO RELATED APPLICATION

This application claims the benefit of U.S. Provisional Patent Application No. 61/937,659 filed on Feb. 10, 2014, the contents of which are incorporated herein by reference.

### FIELD OF THE INVENTION

This invention relates to an improved beehive frame for containing and easily replacing wax honeycomb foundations.

### BACKGROUND OF INVENTION

The production of honey involves the growth and maintenance of a beehive on multiple honeycomb foundations contained within separate honeycomb frames. These honeycomb foundations and frames are supported in side-by-side relation within a rectangular box or housing, referred to as a super, two or more such supers normally being stacked upon one another to form the complete hive

These honeycomb foundations are relatively flat, rectangular-shaped bases containing a plurality of honeycomb indentations on the front and back surfaces. These honeycomb foundations may be composed of wax, plastic, or plastic coated with a thin layer of wax.

For purely wax honeycomb foundations, the wax base is not resilient enough to maintain its relatively flat, rectangular-shape for extended periods of time. Accordingly, the edges of the wax honeycomb foundations are contained within wooden or plastic rectangular frames that surround the relatively flat, rectangular-shape wax foundations. The honeycomb indentations on the front and back surfaces of the wax honeycomb foundation are exposed within rectangular frames. Thin wires horizontally traverse the internal portions of the frame on both sides to contain the soft wax honeycomb foundation while minimizing any impact on the bees' honey-producing activities.

Once a new honeycomb foundation has been deployed, a queen bee will plant her eggs once a honeycomb network has been formed from the honeycomb foundation. It is important that each honeycomb foundation be properly secured so passageways exist between adjoining vertically disposed honeycomb foundations not only to provide ventilation but also to allow the bees to migrate from one area to another.

Bees prefer a wax honeycomb foundation to plastic honeycomb foundation plastic honeycomb foundation coated with wax for producing honey. Bees may not even accept a plastic honeycomb foundation and no hive may form. These wax honeycomb foundations last three to four seasons before replacement is needed and produce more honey yields than plastic honeycomb foundations.

A significant problem with the wax honeycomb foundation is that after three to four seasons of use, the frames become encrusted with beeswax. This makes it incredible difficult and work-intensive to remove the old wax honeycomb foundation from the frames to install a new one.

It is also difficult and work-intensive to remove and replace the thin wires that horizontally traverse the internal portions of the frame on both sides to contain the soft wax honeycomb foundation. These wires must be manually removed from the entire frame, cleaned, and then threaded through the replacement frames over the new wax honeycomb foundation.

The wooden or plastic frames have crevices or holes, especially around their moving parts that separate to remove the old wax honeycomb foundation and install a replacement wax base. Bees are naturally inclined to fill these crevices or holes with beeswax, which may lead to their rejection of entire frame.

The subject invention is a solution to the above-identified problems of wax honeycomb foundation and their frames. The subject invention provides a frame and thin wire structures that allow for easy removal and replacement of wax honeycomb foundations. The frame structures of the subject invention also minimize or eliminate crevices or holes that would be filled by bees with beeswax.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The subject invention discloses an improved honeycomb frame, said frame comprising: an elongate top, bottom, a first wall side, and a second wall side in a common plane defining a first face and a second face about a vertical space for removably holding a honeycomb; at least two wires affixed to the first wall side and the second wall side on the first face; at least two wires removably affixed to the first wall side and the second wall side on the second face, wherein one end of each of the removably affixed wires are detached from the honeycomb frame to allow the honeycomb to be inserted into the vertical space, further wherein the one end of each of the removably affixed wires are reattached to the honeycomb frame to contain the honeycomb in the vertical space.

Another embodiment of the invention discloses an improved honeycomb frame, said frame comprising: an elongate top, bottom, a first wall side, and a second wall side in a common plane defining a first face and a second face about a vertical space for removably holding a honeycomb; at least two wires on a first face of the honeycomb affixed to the first wall side and the second wall side; at least two wires on a second face of the honeycomb, wherein one end of each of wires on the second face are detachable from the honeycomb frame to allow the honeycomb to be inserted into the vertical space, further wherein the one end of each of the wires are reattachable to the honeycomb frame to contain the honeycomb in the vertical space along the second face.

A further embodiment of the invention discloses an improved honeycomb frame, said frame comprising: an elongate top, bottom, a first wall side, and a second wall side in a common plane defining a first face and a second face about a vertical space for removably holding a honeycomb; at least two wires affixed to the first wall side and the second wall side on the first face; at least two wires removably affixed to the first wall side and the second wall side on the second face, wherein one end of each of the removably affixed wires are slidably detached from the honeycomb frame to allow the honeycomb to be inserted into the vertical space, further wherein the one end of each of the removably affixed wires are slidably reattached to the honeycomb frame to contain the honeycomb in the vertical space.

A further embodiment of the invention discloses an improved honeycomb frame, said frame comprising: an elongate top, bottom, a first wall side, and a second wall side in a common plane defining a first face and a second face about a vertical space for removably holding a honeycomb; at least two wires on a first face of the honeycomb affixed to the first wall side and the second wall side; at least two wires on a second face of the honeycomb, wherein one end of each of wires on the second face are slidably detachable from the honeycomb frame to allow the honeycomb to be inserted into the vertical space, further wherein the one end of each of the wires are slidably reattachable to the honeycomb frame to contain the honeycomb in the vertical space along the second face.

An additional embodiment of the invention discloses an improved honeycomb frame, said frame comprising: a substantially parallel elongate top rail and bottom rail; a substantially parallel first side rail and a second side rail, wherein the first and second side rails are substantially perpendicular to the top and bottom rails, further wherein the top, bottom, first side, and second side rails form a substantially rectangular shape with a vertical space defining a first face and a second face for removably holding a honeycomb; at least two first wires affixed to the first side rail and the second wall side on the first face of the vertical space; at least two second wires affixed to the first wall side on a first end on the second face of the vertical space, wherein the first end permits the second two wires to stretch in a lateral direction, wherein a second end of the two second wires is removably attached to the second wall side on the second face of the vertical space, wherein the second ends are detached from the honeycomb frame to allow the honeycomb to be inserted into the vertical space, further wherein the second ends are reattached to the honeycomb frame to contain the honeycomb in the vertical space.

An additional embodiment of the invention discloses a re-useable honeycomb frame, said frame comprising: a substantially parallel elongate top rail and bottom rail; a substantially parallel first side rail and a second side rail, wherein the first and second side rails are substantially perpendicular to the top and bottom rails, further wherein the top, bottom, first side, and second side rails form a substantially rectangular shape with a vertical space defining a first face and a second face for removably holding a honeycomb; at least two first wires affixed to the first side rail and the second wall side on the first face of the vertical space; at least two second wires affixed to the first wall side on a first end on the second face of the vertical space, wherein the first end permits the second two wires to stretch in a lateral direction, wherein a second end of the two second wires is removably attached to the second wall side on the second face of the vertical space, wherein the second ends are detached from the honeycomb frame to allow the honeycomb to be inserted into the vertical space, further wherein the second ends are reattached to the honeycomb frame to contain the honeycomb in the vertical space.

### BRIEF DESCRIPTION OF THE DRAWINGS

Advantages of the present invention will be apparent from the following detailed description of embodiments thereof, which description should be considered in conjunction with the accompanying drawings, in which:

FIG. 1 illustrates a front view of one embodiment of an improved assembled beehive frame.

FIG. 2 illustrates a bottom perspective rear view of the embodiment of the improved assembled beehive frame.

FIG. 3 illustrates a top view of the embodiment of the bottom rail of the improved assembled beehive frame.

FIG. 4 illustrates a top view of the embodiment of the left side rail of the improved assembled beehive frame.

FIG. 5 illustrates a top view of the embodiment of the right side rail of the improved assembled beehive frame.

FIG. 6 illustrates an enlarged cross-sectional view of an embodiment of the compression end of the dynamic wire of the improved assembled beehive frame.

FIG. 7 illustrates an enlarged cross-sectional view of an embodiment of the quick release end of the dynamic wire of the improved assembled beehive frame.

FIG. 8 illustrates an enlarged front view of an embodiment of the quick release end of the dynamic wire of the improved assembled beehive frame.

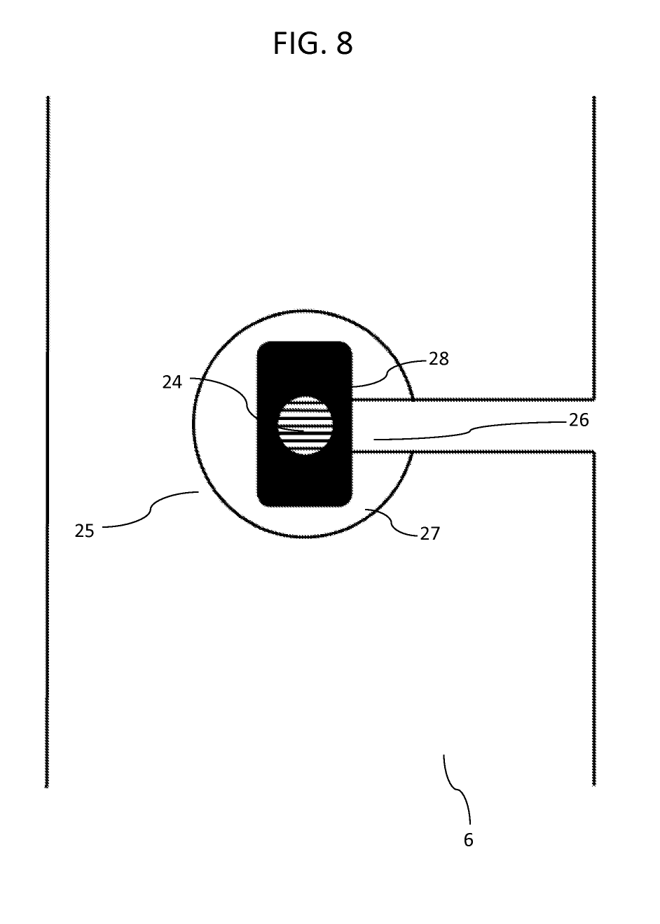

### DETAILED DESCRIPTION OF THE EMBODIMENTS

While several variations of the present invention have been illustrated by way of example in particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

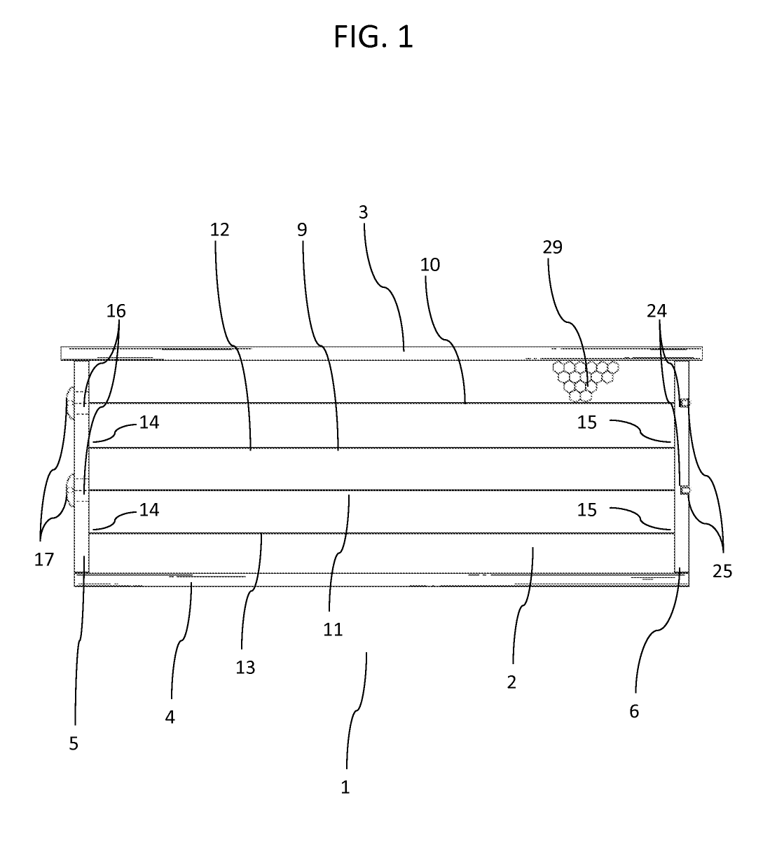

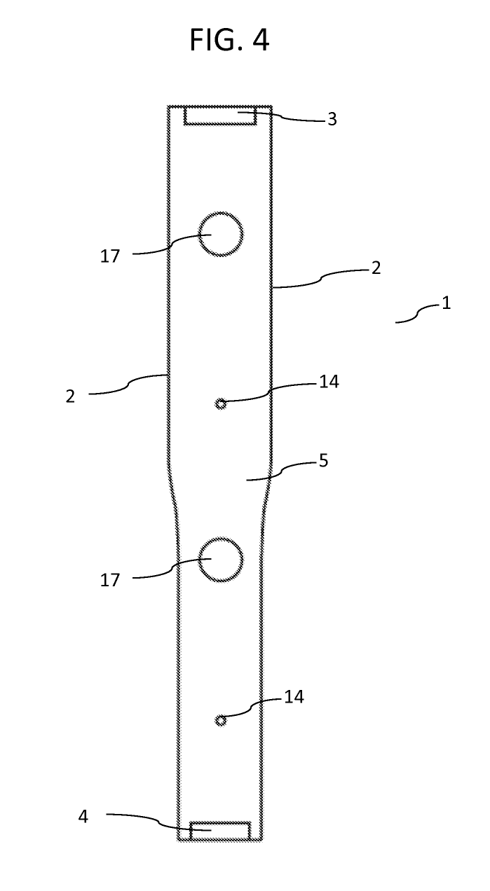

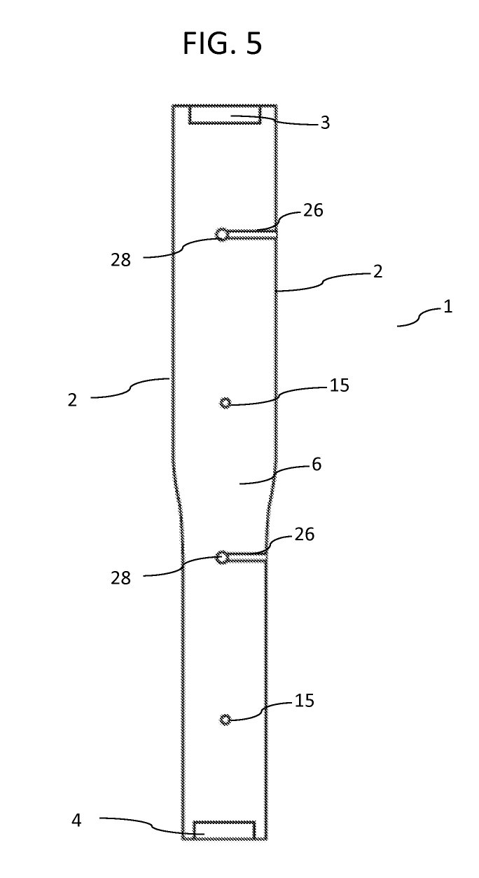

FIGS. 1-7 illustrate an embodiment of the subject invention, an improved honeycomb frame 1 for containing and easily replacing wax honeycomb foundations 28 for a beehive.

This beehive honeycomb frame 1 is composed of a one or two pieces. This beehive honeycomb frame 1 should have as few indentations, relief cuts, and movable parts as possible to avoid distracting any bees in the hive. This beehive honeycomb frame 1 comprises a top rail 3, a bottom rail 4, a left side rail 5, and a right side rail 6. Top rail 3 and bottom rail 4 are substantially parallel and substantially equal in length with each other. Left side rail 5 and right side rail 6 are substantially parallel and substantially equal in length with each other. Top rail 3 and bottom rail 4 are substantially perpendicular with left and ride side rails 5, 6. Rails 3, 4, 5, and 6 each have substantially flat top, bottom, and side surfaces. The corners connecting rails 3, 4, 5, and 6 should be substantially flush to avoid any indentations or relief cuts. Accordingly, the beehive honeycomb frame forms a substantially rectangular shape with two opposing faces 2.

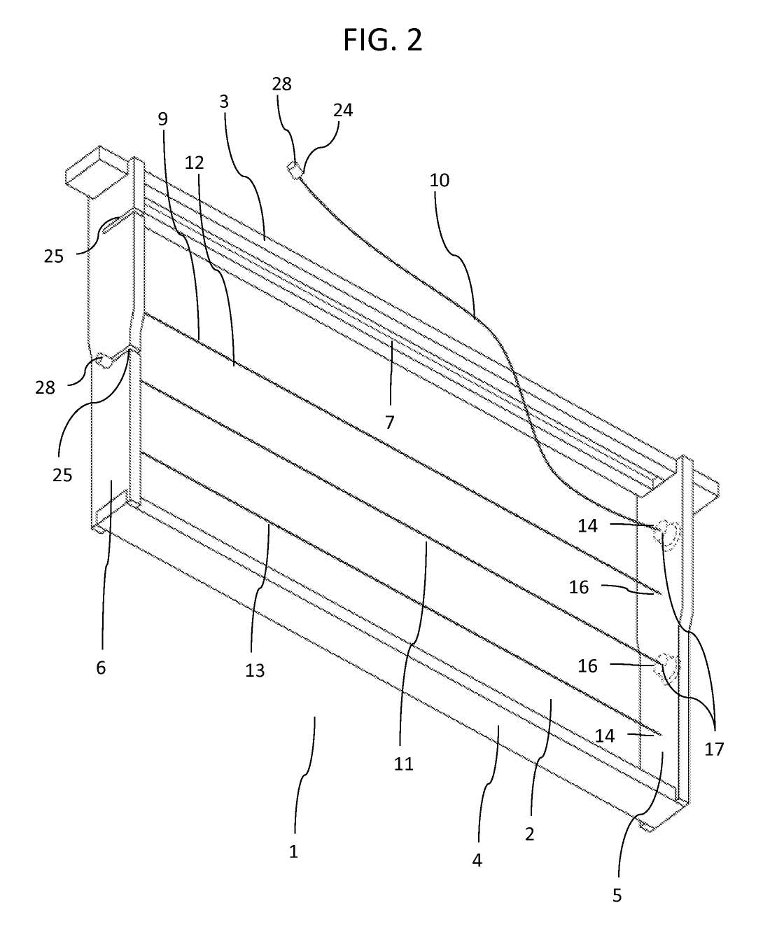

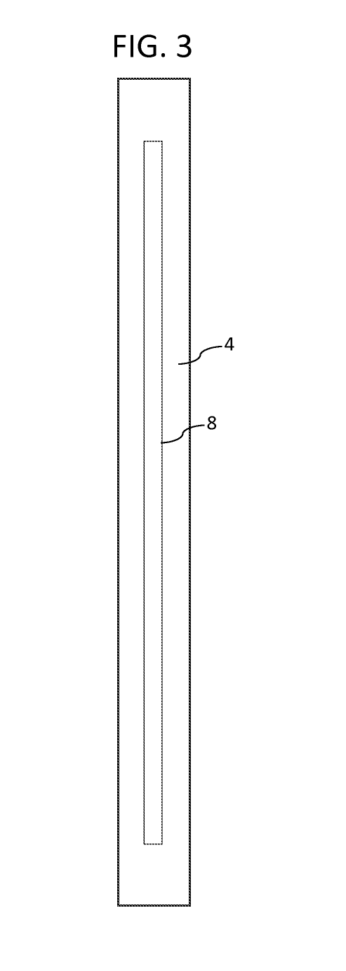

As illustrated in FIG. 2, the beehive honeycomb frame 1 contains a top groove 7 in the top rail 3. As illustrated in FIG. 3, the beehive honeycomb frame 1 contains a bottom groove 8 in the bottom rail 4. In embodiments of the subject invention, the top groove 7 and bottom groove 8 may be 0.1 to 0.4 inches in width, with 0.150 inches in width being the preferred embodiment.

In embodiments of the subject invention, the beehive honeycomb frame 1 may be composed of wood or plastic. In a further embodiment of the subject invention, the beehive honeycomb frame 1 may be formed by standard processes such as injection or pressure molding. In another embodiment of the subject invention, top rail 3, bottom rail 4, and either left side rail 5 or right side rail 6 may be composed of a unitary piece of plastic.

This beehive honeycomb frame 1 further comprises a plurality of thin wires 9 that horizontally traverse over both opposing faces 2 of the honeycomb frame 1. In one embodiment of the subject invention, this thin wire may be AWG-24. In further embodiments of the subject invention, the wires may be 0.01 to 0.1 inches in diameter, with 0.022 inches in diameter being the preferred embodiment.

In embodiments of the subject invention, the thin wires 9 are separated in static, relative unmoveable wires, and dynamic, moveable wires. In the embodiment illustrated in FIGS. 1 and 2, the first wire 10, and the third wire 11 are dynamic, moveable wires, while the second wire 12, and the fourth wire 13 are static, relative unmoveable wires.

The left ends 14 of the static wires 12 and 13 are fixed to the left side rail 5 and the right ends 15 are fixed to the right side rail 6.

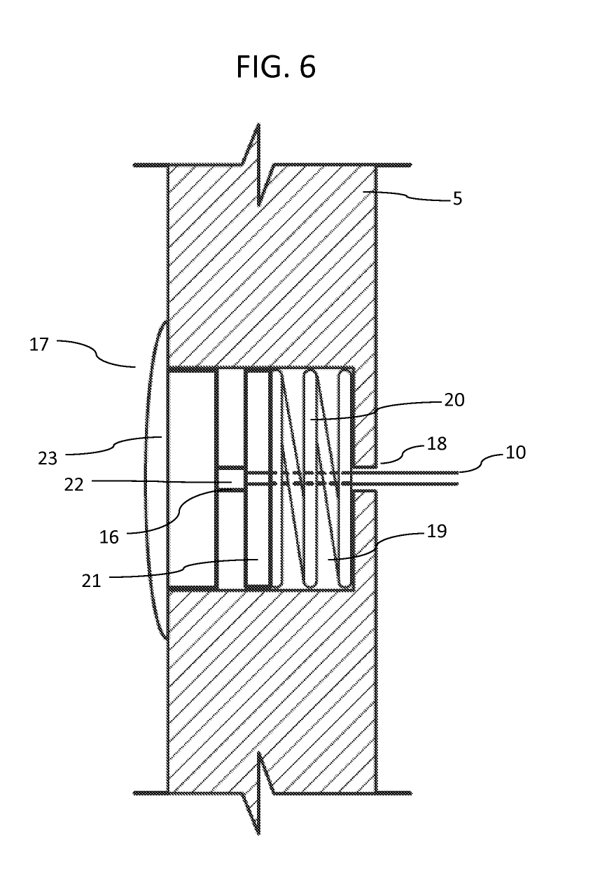

As illustrated in FIG. 6, the left ends 16 of the dynamic wires 10 and 11 are each attached to a compression end 17, illustrated in FIG. 6. In each compression end 17, the left ends 16 of the dynamic wires 10 and 11 pass through a narrow opening 18 into a wider notch 19, which contains a compression spring 20, within the left side rail 5. The left ends 16 of the dynamic wires 10 and 11 are held within the notch 19 with a wire end keeper 21, such as a circular washer. Each of the left ends 16 of the dynamic wires 10 and 11 contains a crimp 22 with a wider diameter to main each left end 16 within the compression end 17. Each notch 19 is covered with an end cap 23. In embodiments of the subject invention, the end cap 23 may be removable to adjust the tension, or replace the dynamic wires 10 and 11, or the spring 20. In embodiments of the subject invention, the notch 19, the wire end keeper 21, and the end cap 23 may be any suitable shape, such as a substantially circular, elliptical, triangular, square, rectangular, pentagonal, hexagonal, heptagonal, or octagonal, with the preferred embodiment being substantially circular.

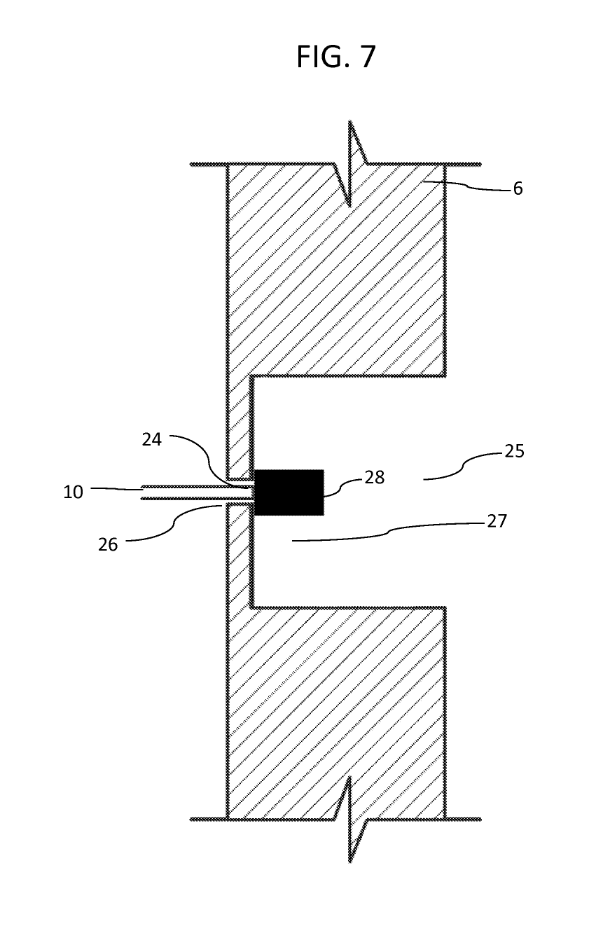

As illustrated in FIG. 7, the right ends 24 of the dynamic wires 10 and 11 are each attached to a quick release end 25 on the right side rail 6. In end quick release end 25, the right ends 24 of the dynamic wires 10 and 11 pass through a narrow opening 26 into a wider notch 27. Each of the right ends 24 of the dynamic wires 10 and 11 contains a crimp 28 with a wider diameter to main each right end 24 within the quick release end 25. In embodiments of the subject invention, the notch 27 may be any suitable shape, such as a substantially circular, elliptical, triangular, square, rectangular, pentagonal, hexagonal, heptagonal, or octagonal, with the preferred embodiment being substantially circular.

Each dynamic wire 10 and 11 is held in a taut horizontal position over the opposing sides 2 of the honeycomb frame 1 by pulling the right ends 24 toward the right side rail 6. This pulling motion pulls the left ends 16 and the wire end keeper 21 towards the spring 20, which compresses against the left side rail 5. Once the right ends 24 of the dynamic wires 10 and 11 are passed through a narrow opening 26 into a wider notch 27 on the right side rail 6, the crimp 28 and the tensed spring 20 hold each dynamic wire 10 and 11 in a taut horizontal position on the honeycomb frame 1. The dynamic wires 10 and 11 may be quickly released from over the honeycomb frame 1 by removing crimp 28 from the quick release end 25 on the right side rail 6 through the narrow opening 26.

In embodiments of the subject invention, the dynamic wires 10 and 11 and the static wires 12 and 13 form a central vertical space for holding a substantially flat, rectangular-shape honeycomb foundation 29, which is composed of wax, within the honeycomb frame 1.

To replace or mount a new wax honeycomb foundation 29 within the honeycomb frame 1, the right ends 24 of the dynamic wires 10 and 11 are removed from the right side rail 6 by removing crimp 28 from the quick release end 25 through the narrow opening 26. Once the dynamic wires 10 and 11 are loose, the bottom of a new wax honeycomb foundation 29 is set within the bottom groove 8 in the bottom rail 4, the top of the foundation 29 is set within the top groove 7 in the top rail 3, and the back face of the foundation 28 is placed gently against static wires 12 and 13.

Once the wax honeycomb foundation 29 is set within the honeycomb frame 1, the right ends 24 of each dynamic wire 10 and 11 is pulled toward the right side rail 6. This pulling motion pulls the left ends 16 and the wire end keeper 21 towards the spring 20, which compresses against the left side rail 5. Once the right ends 24 of the dynamic wires 10 and 11 are passed through a narrow opening 26 into a wider notch 27 on the right side rail 6, the crimp 28 and the tensed spring 20 hold each dynamic wire 10 and 11 in a taut horizontal position over the wax honeycomb foundation 29 on the honeycomb frame 1.

The wax honeycomb foundation 29 is now held with the bottom in the bottom groove 8 in the bottom rail 4, the top within the top groove 7 in the top rail 3, and the back face within static wires 12 and 13, and the front face within dynamic wires 10 and 11. The static wires 12 and 13 and the dynamic wires 10 and 11 contain the soft wax honeycomb foundation while minimizing any impact on the bees' honey-producing activities.

By way of another example, although the springs, bias members, and/or the like have been particularly shown and described above, in other embodiments, any of the springs, bias members, and/or the like can be, for example, any suitable energy storage member or the like. More specifically, any spring and/or bias member configured to be placed in compression can be arranged to be placed in tension, while functioning in a substantially similar manner as described above. Conversely, any spring and/or bias member configured to be placed in tension can be arranged to be placed in compression, while functioning in a substantially similar manner as described above. In some embodiments, any spring and/or bias member described above as being, for example, a torsion spring can, in other embodiments, be arranged in as, for example, a linear spring, while functioning in a substantially similar manner as described above.

In embodiments of the subject invention, the term “substantially” is defined as at least close to (and can include) a given value or state, as understood by a person of ordinary skill in the art. In one embodiment, the term “substantially” refers to ranges within 10%, preferably within 5%, more preferably within 1%, and most preferably within 0.1% of the given value or state being specified.

In embodiments of the subject invention, the term “relatively” is defined as a comparison of a property, or the proportion of a property between two components, the property herein being the deformability between the apex and the legs of the clip.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. These together with other objects of the invention, along with the various features of novelty, which characterize the invention, are pointed out with particularity in the claims annexed to and forming a part of this disclosure.

What is claimed:

1. An improved honeycomb frame, said frame comprising:
an elongate top, bottom, a first wall side, and a second wall side in a common plane defining a first face and a second face about a vertical space for removably holding a honeycomb;
at least two wires affixed to the first wall side and the second wall side on the first face;
at least two wires removably affixed to the first wall side and the second wall side on the second face, wherein one end of each of the removably affixed wires are detached from the honeycomb frame to allow the honeycomb to be inserted into the vertical space, further wherein the one end of each of the removably affixed wires are reattached to the honeycomb frame to contain the honeycomb in the vertical space.

2. An improved honeycomb frame, said frame comprising:
an elongate top, bottom, a first wall side, and a second wall side in a common plane defining a first face and a second face about a vertical space for removably holding a honeycomb;
at least two wires on a first face of the honeycomb affixed to the first wall side and the second wall side;
at least two wires on a second face of the honeycomb, wherein one end of each of wires on the second face are detachable from the honeycomb frame to allow the honeycomb to be inserted into the vertical space, further wherein the one end of each of the wires are reattachable to the honeycomb frame to contain the honeycomb in the vertical space along the second face.

3. An improved honeycomb frame, said frame comprising:
an elongate top, bottom, a first wall side, and a second wall side in a common plane defining a first face and a second face about a vertical space for removably holding a honeycomb;
at least two wires affixed to the first wall side and the second wall side on the first face;
at least two wires removably affixed to the first wall side and the second wall side on the second face, wherein one end of each of the removably affixed wires are slidably detached from the honeycomb frame to allow the honeycomb to be inserted into the vertical space, further wherein the one end of each of the removably affixed wires are slidably reattached to the honeycomb frame to contain the honeycomb in the vertical space.

4. The improved honeycomb frame of claim 1, wherein the honeycomb comprises a wax honeycomb.

5. The improved honeycomb frame of claim 1, wherein the honeycomb comprises a plastic honeycomb.

6. The improved honeycomb frame of claim 1, wherein the two removably wires are substantially taut once attached on both ends to the frame.

7. The improved honeycomb frame of claim 1, wherein the elongate top wall comprises a groove for removably holding the top end of a honeycomb.

8. The improved honeycomb frame of claim 1, wherein the elongate bottom wall comprises a groove for removably holding the bottom end of a honeycomb.
